(19) United States
(12) Patent Application Publication
(10) Pub. No.: US 2005/0280981 A1
(43) Pub. Date: Dec. 22, 2005

(54) Modularized rotatable signal control box

(76) Inventor: Chun-Yao Chen, Chu-Nan (TW)

Correspondence Address: Hoffman, Warnick & D'Alessandro LLC, Three E-Comm Square, Albany, NY, 12207, US

(21) Appl. No.: 11/154,753

(22) Filed: Jun. 16, 2005

(30) Foreign Application Priority Data
Jun. 18, 2004 (TW) 093117780

(51) Int. Cl. G06F 1/16

(52) U.S. Cl. 361/682

(57) ABSTRACT

The invention provides a modularized rotatable signal control box which is assembled in a housing of an electronic appliance. The signal control box comprises a module base and a rotatable module. The module base is assembled in the housing of the electronic appliance. The rotatable module comprises a hidden panel and at least one rotating element. The hidden panel comprises at least one signal input/output connector, and the rotating element is used for rotatably connecting the rotatable module to the module base.

### BACKGROUND OF THE INVENTION

1. Field of the invention

This present invention relates to a signal control box, especially to a modularized rotatable signal control box.

2. Description of the prior art

As upright rear projection televisions become more popular, consumers place importance on the performance of the video, audio, and control of the upright rear projection television. The video and the audio of the upright rear projection television are controlled by the audiovisual/control signal, and the audiovisual/control signal comprises a set of video signals, a set of audio signals, and a set of control signals. What consumers place importance on is not only that the various audiovisual/control signals can be controlled, but also that the audiovisual/control signal element or the terminal can be utilized to control the functional operations of the upright rear projection television.

Referring to FIG. 1, FIG. 1 is a schematic diagram of the audiovisual/control signal element 12 of the upright rear projection television 10 of the prior art. The audiovisual/control signal element 12 of the upright rear projection television 10 of the prior art is protected by a cover 14; when the audiovisual/control signal element 12 is being used, the cover 14 will be opened. The audiovisual/control signal element 12 only provides three different kinds of signal control. Therefore, when there are other new audiovisual/control signals to be added into the upright rear projection television 10, the upright rear projection television 10 must be disassembled before the audiovisual/control signal element 12 can be changed. The process is inconvenient and time-consuming.

### SUMMARY OF THE INVENTION

An objective of the invention is to provide a modularized rotatable signal control box that is assembled in an electronic appliance; it can be altered in a convenient and a time-saving way when a new kind of audiovisual/control signal needs to be added to the rotatable signal control box.

Another objective of the invention is to provide a modularized rotatable signal control box that is used for transmitting at least one audiovisual/control signal to an electrical appliance comprising the rotatable signal control box, so as to control the functional operations of the electrical appliance.

Still another objective of the invention is to provide a rotatable signal control box that can be an independent module; this module can be used in different electrical appliances to increase its flexibility.

In a preferred embodiment, a modularized rotatable signal control box of the invention is installed inside the housing of an electronic appliance. The signal control box comprises a module base and a rotatable module. The module base is assembled inside the housing of the electronic appliance. The rotatable module comprises a hidden panel and at least one rotating element. The hidden panel comprises at least one signal input/output connector. The rotating element is used for rotatably connecting the rotatable module to the module base. The hidden panel of the rotating element is hidden in the housing of the electronic appliance when the hidden panel is not being used, and the hidden panel can be exposed by rotating the rotating element when the hidden panel is being used. After the hidden panel is being used, it can be hidden by once again rotating the rotating element.

According to the invention, a customer can transmit at least one audiovisual/control signal to the rotatable signal control box by the signal input/output connector, for later receiving and transmitting of the audiovisual/control signal to the electronic appliance, so as to control the functional operations of the electronic appliance; furthermore, the electronic appliance manufacture factories can save time when they add a new kind of audiovisual/control signal to the rotatable signal box to further develop new functions of the new kind of audiovisual/control signal.

The advantage and spirit of the invention may be understood by the following recitations together with the appended drawings.

### BRIEF DESCRIPTION OF THE APPENDED DRAWINGS

FIG. 1 is a schematic diagram of the audiovisual/control signal element of an upright rear projection television of the prior art.

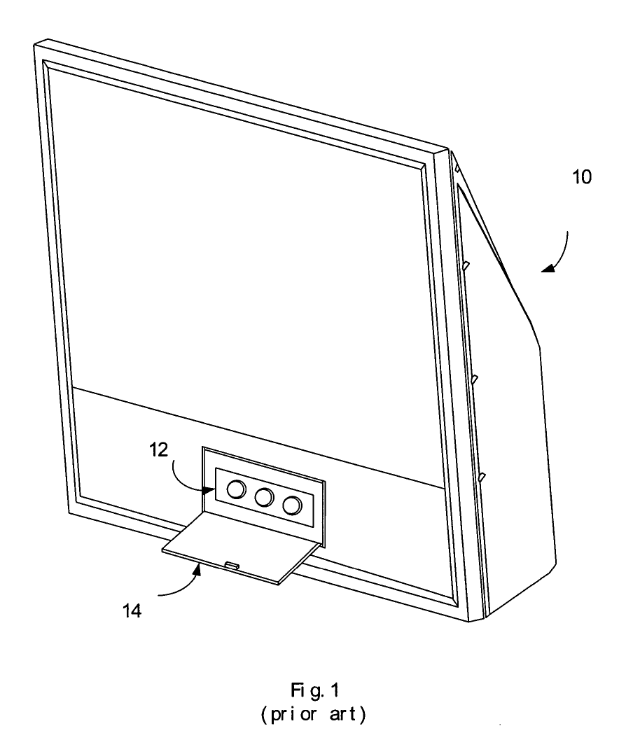

FIG. 2 is a schematic diagram of a rotatable signal control box that is assembled in a housing of an electronic appliance of the present invention.

FIG. 3 is a schematic diagram of the rotatable signal control box of FIG. 2 that is in the using state.

FIG. 4 is a diagram of the rotatable signal control box of FIG. 2 and FIG. 3.

FIG. 5 is a schematic diagram of the back of the rotatable signal control box.

FIG. 6 is an exploded diagram of the rotatable signal control box.

### DETAILED DESCRIPTION OF THE INVENTION

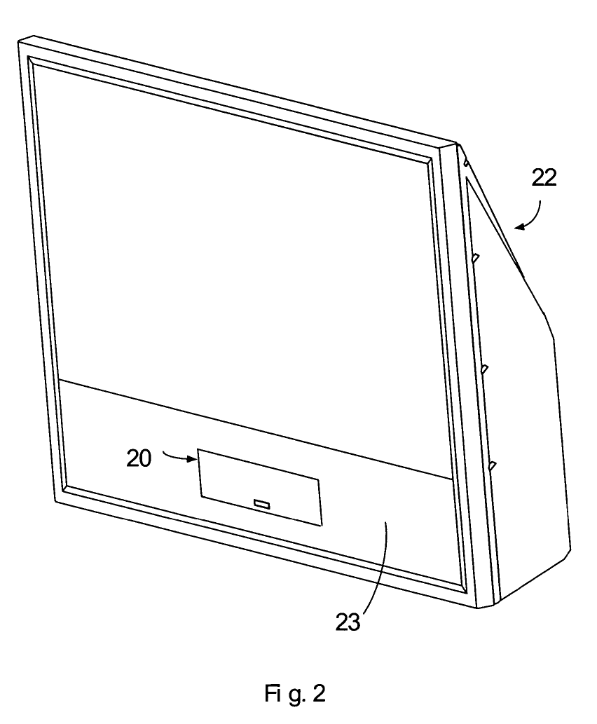

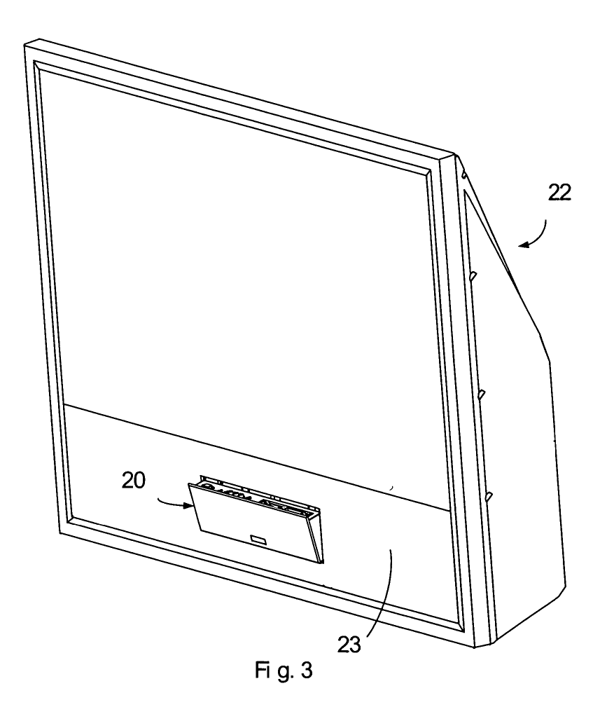

Referring to FIG. 2 and FIG. 3, FIG. 2 is a schematic diagram of the rotatable signal control box 20 which is assembled in a housing 23 of an electronic appliance 22 of the present invention; FIG. 3 is a schematic diagram of the rotatable signal control box 20 of FIG. 2 which is in the using state. In an embodiment, the electronic appliance 22 is an upright rear projection television; the rotatable signal control box 20 of the invention is assembled in a housing 23 of the upright rear projection television. The rotatable signal control box 20 is used for transmitting at least one audiovisual/control signal to the electronic appliance 22 to control the functional operations of the electronic appliance 22. The audiovisual/control signal comprises at least a video signal, an audio signal, an S-video signal, and a control signal.

As shown in FIG. 2, the main part of the rotatable signal control box 20 is hidden in the housing 23 when the user is not using the rotatable signal control box 20. In this state, the elements of the rotatable signal control box 20 cannot be seen, and the hidden panel is located in a first position (not shown in FIG. 2)

On the other hand, when the user wants to use the rotatable signal control box 20, the rotatable signal control box 20 can be opened rotatably, as shown in FIG. 3.

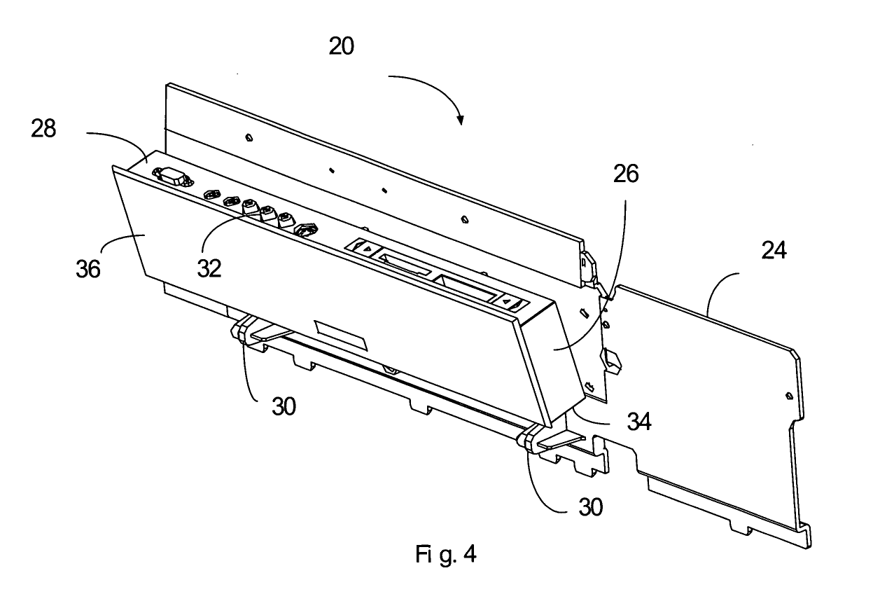

Referring to FIG. 4, FIG. 4 is a diagram of the rotatable signal control box 20 of FIG. 2 and FIG. 3. The rotatable signal control box 20 of the invention comprises a module base 24 and a rotatable module 26. The module base 24 is assembled in the housing 23 of the electronic appliance 22. The rotatable module 26 comprises a hidden panel 28, two rotating elements 30, a module chassis 34, and a module cover 36.

As shown in FIG. 4, the rotating element 30 is used for rotatably connecting the rotatable module 26 to the module base 24. Two rotating elements 30 are installed on two sides of the module chassis 34; the module chassis 34 is coupled to the module base 24 by the two rotating elements. The module cover 36 is installed on the module chassis 34, and the hidden panel 28 is installed on the surface of the module cover 36; there is a plurality of protrudent signal input/output connectors 32 on the hidden panel 28, and the signal input/output connector 32 is used for receiving and transmitting audiovisual/control signals to the electronic appliance 22 to control the functional operations of the electronic appliance 22.

Referring to FIG. 2, FIG. 3 and FIG. 4, the signal input/output connector 32 of the rotatable module 26 can be hidden in the housing 23 of the electronic appliance 22 when the signal input/output connector 32 is not being used. On the other hand, when the user wants to use the signal input/output connector 32, the signal input/output connector 32 can be shown rotatably by the rotating element 30; then, the signal input/output connector 32 can be hidden again rotatably by the rotating element 30 when the user finishes using it.

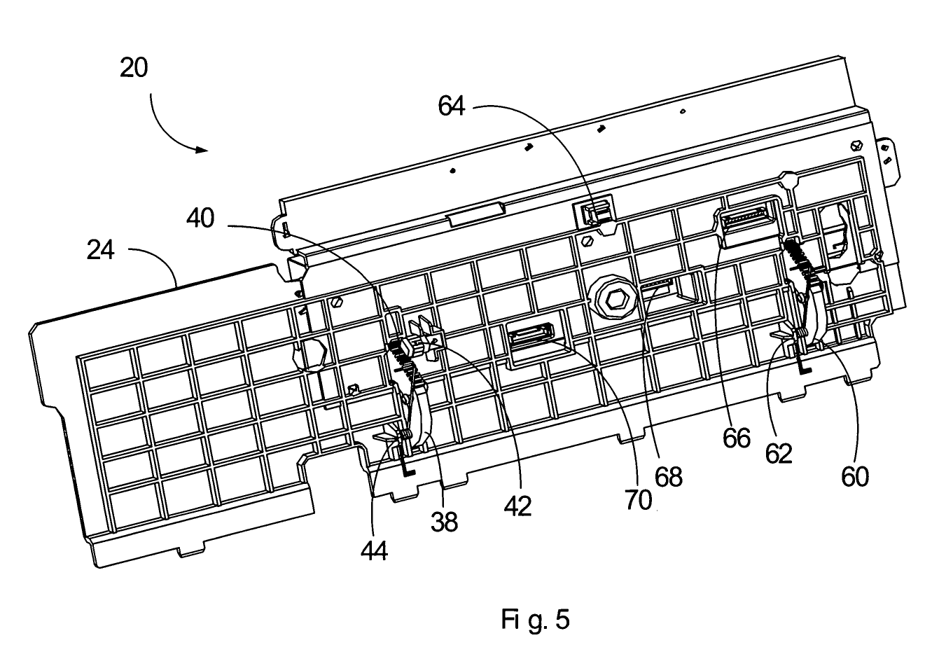

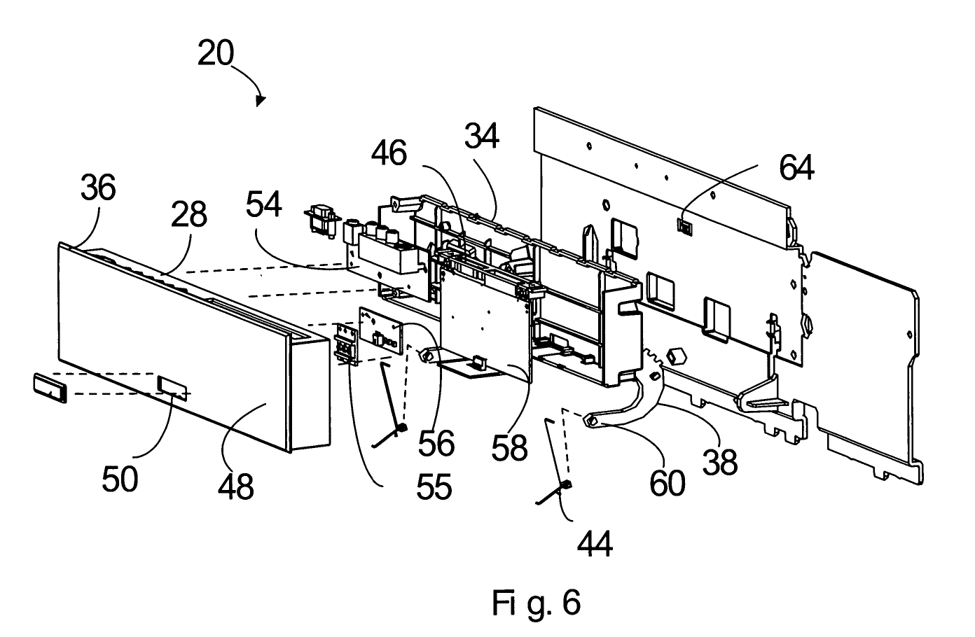

In the embodiment of FIG. 4, the hidden panel 28 comprises several signal input/output connectors 32 which are used for receiving and transmitting audiovisual/control signals to the electronic appliance 22, so as to control the functional operations of the electronic appliance 22. Referring to FIG. 4, FIG. 5, FIG. 6, FIG. 5 is a schematic diagram of the back of the rotatable signal control box 20; FIG. 6 is an exploded diagram of the rotatable signal control box 20 of FIG. 4. The module base 24 further comprises two fixed base 62, a damping gear 42, and a slot 64. The rotatable module 26 further comprises a hook (not shown in the figure) that can fix the rotatable module 26 onto the module base 24 by the combination of the hook and the slot 64.

The rotating element 30 comprises a L-shape spring 44 and an arcuate prop 38; a first end 60 of the arcuate prop 38 together with the L-shape spring 44 are fixed onto the fixed base 62 of the module base 24 in a rotatory manner, and the other end of the arcuate prop 38 which comprises a plurality of tooth-like salients 40 is fixed onto the module chassis 34 so as to be engaged with a corresponding damping gear 42 of the module base 24 (shown in FIG. 5).

Referring to FIG. 2 to FIG. 6, when the user separates the hook and the slot 64, the recoiling force of the L-shape spring 44, which is generated by the compression of the spring, forces the hidden panel 26 to be exposed in a rotatable manner; the damping gear 42 will then generate a resistance for the arcuate prop 38 to rotate the rotatable module 26 around the first end 60 in a slower speed and to expose the hidden panel 28 to be located in a second position. Thus, the plurality of signal input/output connectors 32 of the hidden panel 28 can be exposed by the rotation of the rotating element 30 of the rotatable module 26, so as to receive and transmit the audiovisual/control signals to the electronic appliance 22 and to control the functional operations of electronic appliance 22.

As shown in FIG. 6, the hidden panel 28 of the rotatable module 26 further comprises a memory read slot 46 for inserting a memory card. The electronic appliance 22 can load the memory card when the memory card is inserted into the memory card loading slot 46 of the rotatable signal control box 20 which is installed in the electronic appliance 22.

As shown in FIG. 4 and FIG. 6, the module cover 36 of the rotatable module 26 further comprises an outside appearance panel 48 with a window 50; a light-emitting diode (not shown) and an infrared rays element (not shown) installed in the electronic appliance 22 radiate/receive a light signal through the window 50.

As shown in FIG. 5 and FIG. 6, the module chassis 34 comprises an I/O print circuit board assembly (I/O PCBA) 54, a LED PCBA 55, an IR PCBA 56, and a card reader PCBA 58, wherein the I/O print circuit board assembly (I/O PCBA) 54 comprises a first terminal 66. The LED PCBA 55 is connected to the IR PCBA 56 which has a second terminal 68. The card reader PCBA 58 has a third terminal 70; the first terminal 66, the second terminal 68, and the third terminal 70 are electrically connected to the motherboard (not shown) of the electronic appliance 22 by a bus line (not shown).

When the user wants to input a new kind of audiovisual/control signal to the electronic appliance 22, the manufacture factory of the electronic appliance 22 can simply put in a corresponding input connector and a corresponding PCBA of the new kind of audiovisual/control signal into the rotatable signal control box 20.

Thus, when the user wants to use a new kind of audiovisual/control signal, by the rotatable signal control box 20 of the embodiment of the invention, the manufacture factory of the electronic appliance 22 just needs to add a new kind of audiovisual/control signal into the rotatable signal control box 20, without having to take apart the electronic appliance 22; in this way, time can be saved.

The modularized rotatable signal control box of the present invention can control the functional operations of the electronic appliance by transmitting the audiovisual/control signal to the electronic appliance. When the user is not using the signal input/output connector 32, the hidden panel 28 can be located in a first position, that is, hidden in the housing of the electronic appliance 22; when the user wants to use the signal input/output connectors 32, the hidden panel 28 can be exposed rotatably, that is, located in a second position.

Furthermore, when the manufacture factory of the electronic appliance 22 wants to add a new kind of audiovisual control signal, it just needs to add a new kind of audiovisual/control signal into a rotatable signal control box 20 and change from the original rotatable signal control box to the new signal control box without taking apart the electronic appliance 22. Thus, it can be used in a convenient and a time-saving way.

Besides, as the rotatable signal control box can be an independent module and can be installed in the electronic appliance in an easy way, the signal control box can be used in different electrical appliances to raise its flexibility.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A modularized rotatable signal control box assembled in a housing of an electronic appliance, the signal control box comprising:
a module base assembled in the housing of the electronic appliance; and
a rotatable module comprising:
a hidden panel comprising at least one signal input/output connector, and
at least one rotating element for rotatably connecting the rotatable module to the module base;
wherein the hidden panel is hidden in the housing of the electronic appliance when the hidden panel is located in a first position, and the hidden panel is exposed by rotating the rotating element when the hidden panel is located in a second position.

2. The modularized rotatable signal control box of claim 1, wherein the signal input/output connector is used to receive and transmit a signal to the electronic appliance, and the signal comprises a video signal, an audio signal, a control signal or an S-video signal.

3. The modularized rotatable signal control box of claim 1, wherein the rotatable module further comprises:
a module chassis, the rotating element being installed in the module chassis, the module chassis being coupled to the module base by the rotating element; and
a module cover being coupled to the module chassis, and the hidden panel being installed on a surface of the module cover.

4. The modularized rotatable signal control box of claim 3, wherein the module chassis comprises an I/O print circuit board assembly, a LED & IR PCBA, or a card reader PCBA.

5. The modularized rotatable signal control box of claim 3, wherein the rotating element comprises an L-shape spring and an arcuate prop, one end of the arcuate prop being fixed on the module base in a rotatable manner, the other end of the arcuate prop comprising a plurality of tooth-like salients being fixed in the module chassis to be engaged with a corresponding damping gear of the module base.

6. The modularized rotatable signal control box of claim 5, wherein the damping gear generates a resistance for the arcuate prop to rotate the rotatable module in a slow speed and expose the hidden panel when the L-shape spring forces the rotatable module to rotate and to be exposed.

7. The modularized rotatable signal control box of claim 1, wherein the electronic appliance is an upright rear projection television.

8. The modularized rotatable signal control box of claim 1, wherein the hidden panel of the rotatable module further comprises a memory read slot.

9. The modularized rotatable signal control box of claim 1, wherein the rotatable module further comprises an outside appearance panel with a window, and a light-emitting diode or an infrared rays element installed in the electronic appliance radiates a light signal through the window.
